(19) United States
(12) Patent Application Publication
(10) Pub. No.: US 2020/0314244 A1
(43) Pub. Date: Oct. 1, 2020

(54) ONE-TO-MANY AGENT-TO-AGENT CONSULTATION

(71) Applicant: Avaya Inc., Santa Clara, CA (US)

(72) Inventors: Valentine C. Matula, Granville, OH (US); Bharti Patwari Poorey, Pune (IN); Rajagiri Ravi, Pradesh (IN)

(21) Appl. No.: 16/370,535

(22) Filed: Mar. 29, 2019

(51) Int. Cl. H04M 3/523; G06Q 10/06; H04M 3/58; G06Q 30/08

(52) U.S. Cl. CPC H04M 3/5233; G06Q 10/063112; G06Q 30/08; G06Q 10/063116; H04M 3/58

(57) ABSTRACT

Agent-to-Agent channel interactions enable one agent to pose a question to another agent and have the request routed utilizing at least a portion of the routing hardware and algorithms utilized to route work items received from customers. A question may be asked and the network routing components notified of the question and routed to selected agent or agents to address the issue. The selected agents are then connected via the Agent-to-Agent channel and enabled to converse thereon. A successful (or failed) resolution may be utilized to update or modify question repositories for future access and/or training.

### CROSS-CITATION TO RELATED APPLICATIONS

The present application incorporates by reference U.S. application Ser. No. 16/370,462 filed Mar. 29, 2019 entitled “AGENT-TO-AGENT CONSULTATION AS FORMALLY MANAGED CHANNEL FOR ASSISTANCE” and presently identified as attorney docket number 4366-1123, the entire disclosure of which is hereby incorporated by reference.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communications between networked nodes and particularly to channel-specific communications for use by such nodes.

### BACKGROUND

In a call center, the live agents use different means when they are in need of help while handling a contact (e.g., a customer utilizing a communication device). One of these means is to consult another agent. In a busy call center, where all the other agents are busy handling tasks, it may become difficult to find and connect to a free agent, using instant messaging (IM) or directly dialing, in order to get assistance.

Currently an agent who requires information may:

a. Look in knowledge bases or ask an automated search computer(s) configured with one or more algorithms or one or more “bot.”: Such systems may not provide complete answers and generally are significantly time consuming. This is particularly problematic if the agent currently has a real-time communication ongoing with the customer.

b. Check with supervisor: The supervisor may be busy or otherwise unavailable.

c. “Ping” another agent who may know the answer, such as by utilizing presence information and directly messaging the agent (similar to a unified communication (UC) telephone call in routing): However, the agent may not be aware of the best person to contact or, if known, the other may not be free to answer this query.

d. Have a consultation-transfer/conference: Here to, the agent must know who to contact and the other agent must be available.

Being able to query another agent to address a minor issue, allows knowledge of the solution to be obtained by the original agent and allow the agent to proceed with the work item to resolution without the overhead associated with transferring the customer communication to another agent. However, even with such solutions available, problems remain.

### SUMMARY

These and other needs are addressed by the various embodiments and configurations of the present invention. The present invention can provide a number of advantages depending on the particular configuration. These and other advantages will be apparent from the disclosure of the invention(s) contained herein.

In one embodiment, a new strategy for agent-agent consultation is provided which may leverage the use and benefits of current multi-channel platforms. And, new additional sub-feature of escalating chat-to-voice within contact center consultations for communications between agent and/or agent with customer. In one embodiment, an agent-to-agent assist channel is provided. In another embodiment, a one-to-many agent assist channel is provided.

For example, agents may have a number of permitted concurrent communications comprising customer communication devices. For example, 1 voice call, 2 emails and 3 chats. As described herein, an agent may seek multiple connections to multiple agents in a dedicated agent-to-agent assist communication channel that is separate from the permitted customer communication devices.

In another embodiment, a posting for an agent-to-agent query is provided to a plurality of agents, this may occur in a pre-accept phase. When an agent accepts the query, such as by determining that they can address all or part of the query, they will cancel and/or revoke the posting being presented to other agents.

In another embodiment, a query-response agent node is added to the existing multiplicity options and operate independently therefrom. Herein, this is known as, “as Quick Assist Node.” For example, multiplicity factors of an agent may look like 1 maximum concurrent voice, 2 emails, 2 chats and 1 Quick Assist channels respectively.

An agent in need of quick assistance will frame the query and raise it to a routing engine. Agent can use different means to create the query such as speech, text, speech to text, video, etc. and then be routed and connected utilizing the mode (e.g., text, voice, video, co-browsing, etc.) selected for the query.

A routing engine may then identify the best matching number of agents and post the query to them (via their respective networked agent communication devices). The existing routing mechanisms may be configured to identify and post the query to the identified agents.

Inputs into assessing top number of agents can be any/all of current available technology: Avaya Conversational Intelligence+ “Progress analytics” module, agent self-assessment, customer input via separate co-browsing/digital interface, and/or other mechanisms or paradigms.

The top number of matching agents are them provided with alerts requesting quick help along with the query. The path of the first agent agreeing to the assist will cancel the other paths of assistance request.

The contact center may have configuration for attributes including, but not limited to, incentives for agents providing quick assist in busy hours, a maximum number of quick assists allowed per agent, configuration as one of a query-response model or one-to-one chat model, and/or prioritization of quick assist requests overall and/or by a request attribute.

In another embodiment, analysis of these assist queries may be utilized, alone or in part, to determine agents' skill levels, knowledge sharing (e.g., building knowledge bases, assistance bots, and/or training new agents), assistance in generating satisfaction ratings, and/or the publication of guidelines for reference.

One benefit of at least certain embodiments provided herein, is that one agent, who is unable to complete a work item, does not need to transfer the work item or place the customer on hold while assistance from a supervisor or other party becomes available. With minimal delay, question can be asked and addressed and the original agent may continue with the work item.

In another embodiment, agents may select or ‘bid’ on assistance requests. Additionally or alternatively, the result of the assistance may be positive (e.g., sufficient or better) or negative (e.g., insufficient or worse) such that assistance from a different agent or alternative means is required. From analytics, contact centers may determine any one or more of: phrasing that best describes issues that result in good assignments and solutions, which may trigger or perform modification to knowledge bases or other resources to provide standardization of internal terms and language; agents that bid but fail, which may trigger additional training or coaching; setting and monitoring progress to performance goals for successfully, completely, efficiently and/or quickly responding to assist requests; combining times of first agents and follow-on agents, creating the idea of team statistics (e.g., each agent involved in the assist, which may further comprise the original agent), whereby there is incentive to serve customers directly, but be confident and rewarded if time to transfer and assist is less than that encountered by an agent attempting to resolve the issue without assistance.

In one embodiment, a system providing communications between nodes on a network, comprising: a microprocessor; a memory; a network interface facilitating communications between nodes on the network, wherein each of the nodes is configured to engage communications utilizing a fixed number of communication channels; upon receiving notification, from a requesting node of the number of nodes, for an agent-to-agent assist, selecting offered nodes of the number of nodes eligible to receive the Agent-to-Agent assist and sending to the offered nodes, indicia of the Agent-to-Agent assist; upon receiving notification, from an accepting node of the offered nodes, acceptance of the Agent-to-Agent assist, allocating one of the fixed number of communication channels for each of the requesting node and accepting nodes and connecting the requesting node and the accepting node thereon.

In another embodiment, an agent communication device is disclosed, comprising: a microprocessor; a memory; a network interface facilitating communications via the network; wherein the microprocessor is configured to engage a fixed number of communication channels, via the network; upon receiving notification of an agent-to-agent assist task being available, presenting indicating of the Agent-to-Agent assist task on a display component; and upon receiving an input from an agent indicating a desire to have the Agent-to-Agent assist task, routing the Agent-to-Agent assist to the agent communication device.

In another embodiment, a method for providing connectivity between nodes on a network is disclosed, comprising: receiving, from a requesting node of the nodes on the network, notification of an agent-to-agent assist request, wherein each of the nodes on the network has a fixed number of communication channels for use in communicating with other nodes on the network; sending, from a router, indicia of the notification to a plurality of offered nodes of the nodes on the network; receiving, from an accepting node of the offered nodes, indicia of acceptance; and upon receiving the indicia of acceptance, allocating one of the fixed number of communication channels for each of the requesting node and accepting nodes and connecting the requesting node and the accepting node thereon.

In another embodiment, the agent-to-agent assist utilizes an agent-to-agent interaction channel.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a portion of system in accordance with embodiments of the present disclosure;

FIG. 3 depicts a first process in accordance with embodiments of the present disclosure;

FIG. 4 depicts a second process in accordance with embodiments of the present disclosure;

FIG. 5 depicts a third process in accordance with embodiments of the present disclosure;

FIG. 6 depicts a data storage system in accordance with embodiments of the present disclosure;

FIG. 7 depicts an interaction in accordance with embodiments of the present disclosure;

and

FIG. 8 depicts a device in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

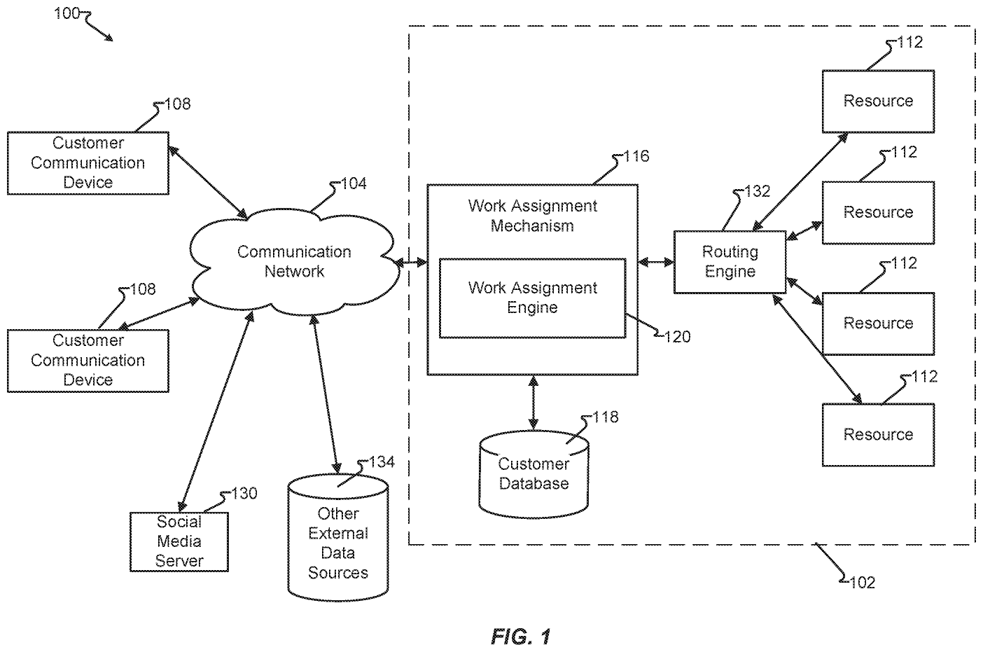

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media website 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server 130. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage elements may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

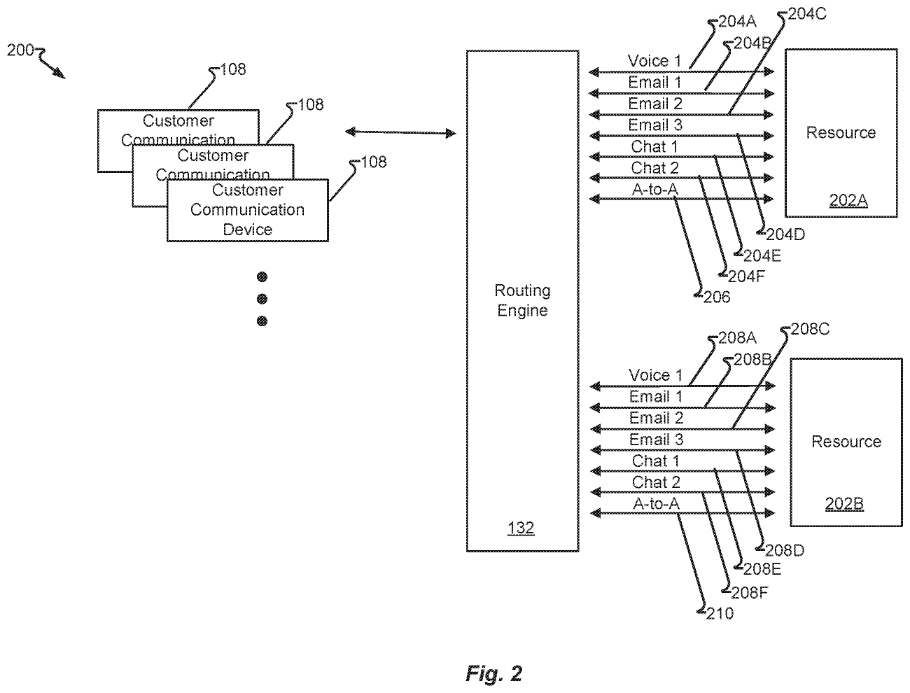

FIG. 2 depicts portions 200 of a system in accordance with embodiments of the present disclosure. In one embodiment, portions 200 are portions of system 100. For clarity and to avoid unnecessarily complicating the figures, components that may be utilized in portions 200 are omitted (e.g., edge devices, network switches, etc.). In one embodiment, a number of customer communication devices 108 are connected to a number of resources 202. Resources 202 are each an embodiment of resource 112 when embodied as a human agent utilizing an agent communication device (e.g., networked computer, telephone, softphone, endpoint, etc.) enabled to support two or more communication channels. For example, each of resource 202A and resource 202B are illustrated as each having one voice, three email, two chat, and one agent-to-agent channel enabled, such as by a configuration of their respective agent communication device and/or a configuration of a different component of portion 200 managing the channels, such as routing engine 132. While resources 202A and 202B are illustrated as having the same connectivity enabled, in other embodiments other connectivity's are enabled/disabled. For example, one resource 202 may only be enabled for a single voice channel and no other customer-interaction channels, another resource 202 may be enabled for eight text chat channels and one email channel and no voice channels, etc. It should also be appreciated that the configuration of channels 204, 208 may be dynamic. For example, an agent comprising a portion of resource 202A may be engaged with a customer via voice channel 204A. If the content of the voice channel requires a significant amount of idle time, such as the customer is known to need several minutes to perform a particular operation, resource 202A may be dynamically reconfigured to add another voice channel, such as with a different customer utilizing a different customer communication device 108, such as with a customer whose associated work item is anticipated to be completed during the time period in which the first customer is performing their operation. This may cause the number of non-voice channels (e.g., email channel 204B, 204C, 204D, chat 204E, 204F) to be maintained or temporarily reduced.

However, each resource 202 consists of utilization of one Agent-to-Agent channel, such as Agent-to-Agent channel 206 for resource 202A and Agent-to-Agent channel 210 for resource 202B. In another embodiment, at least one resource 202 comprises more than one Agent-to-Agent channel. Having a plurality of Agent-to-Agent channels, while enabled by certain embodiments herein, is unlikely as the intended usage is to allow agents to have a quick conversation with another agent while the customer remains engaged and without transferring the customer. However, other usages of the Agent-to-Agent channel may warrant implementations of more than one such channel.

Routing engine 132 receives channel requests from each of the plurality of customer communication devices 108. In another embodiment, routing engine 132 may initiate one or more communication requests with customer communication devices 108 (e.g., for an outbound campaign). Customers, via their respective customer communication device 108, is then connected to one of resources 202 via a communication channel 204 or 208, such as voice channel 204A; email channel 204B, 204C, 204D; text chat channel 204E, 204F, for resource 202A or voice channel 208A; email channel 208B, 208C, 208D; text chat channel 208E, 208F, for resource 202B. Customers are more generally sensitive to delays and idle progress with real-time communications (e.g., voice communications). Accordingly, the embodiments herein are primarily directed to examples wherein an agent is engaged in a voice communication and requires the assistance of another agent, which requires the customer to wait, such as via being placed on hold. However, it should be appreciated that such embodiments may be utilized for agents engaged in other forms of communications with a customer without departing from the scope of the embodiments herein.

In one embodiment, resource 202A may request an Agent-to-Agent channel of a specific agent or a agents having a specific agent attribute (e.g., member of the international reservations team, expert in “product A,” native Portuguese speaker, senior technical expert, etc.). In one embodiment, such as when a request is made to a specific agent, for example, resource 202B the request is denied if Agent-to-Agent channel 210 is currently in use. In another embodiment, routing engine 132 responds to resource 202A with a notification that the request failed, which may further comprise notification that the selected resource is currently not available to accept the Agent-to-Agent communication.

In another embodiment, routing engine 132 may managing the Agent-to-Agent channels in the same manner and utilizing the same algorithms, with different input variables, as those utilized for customer-agent communications. For example, customers, with their respective customer communication device 108 may enter contact center 102 via an automated resource 112, such as an interactive voice response unit or other analysis engine. For example, a customer may select an option to talk to a billing representative or tell an automated resource 112 that, “I have a question about my bill.” Accordingly, routing engine 132, alone or in concert with another component (e.g., work assignment mechanism 116, customer database 118, etc.) may determine that the call should be routed to a particular set or group of agents. The call is then enqueued to one or more agents.

In another embodiment, a denied request may be automatically forwarded to another agent. However, automatic forwarding may be disabled for a particular request, for a particular requesting agent, subject matter, etc. In other embodiments, a denied request may be enqueued for processing later. As the motivation for the use of Agent-to-Agent channels are typically time-sensitive, the wait time in queue may be reported back to the requestor or automatically dequeued if the wait time is above a threshold, which may be zero (e.g., the requested agent is currently able to accept the Agent-to-Agent channel usage request) to a few seconds. For example, an agent wishing to ask a quick question of a peer (e.g., “I can't remember how to select . . . . Where is that?”) may have a default tolerance to wait, such as fifteen seconds, or select an option (e.g., “now or never”) that requires the request to be honored immediately (e.g., within a few seconds) or the request is withdrawn and manually or automatically forwarded to another agent having the same or similar attribute.

In another embodiment, routing engine 132 and/or work assignment mechanism 116, work assignment engine 120, or a combination thereof, receives queries from customer communication devices 108 and resource 202A in substantially identical means. For example, a text message from a customer (e.g., “I have a question about my bill”) may be parsed and an agent selected who can address billing questions. Similarly, a text message from one agent (e.g., “How do I get back to the screen to select a different . . . ?”) may be parsed and an agent selected who can address screen-flow issues. In a further embodiment, to avoid routing customers via the Agent-to-Agent channels and agents to customer-facing communications channels, the source of the message may be considered. For example, resource 202A may have a known or membership in a group (e.g., subnet) of network addresses or that are associated with an internal network address, utilize a port on a switch or other network hardware known to be associated with internal devices, not utilizing a port or address utilized by customer communication devices 108, etc. Accordingly, a question such as, “How do I . . . ” may be routed to a first portion of customer-facing communication channels (e.g., voice channels 204A, 208A; email channels 204B, 204C 204D, 208B, 208C, 208D; text chat channels 204E, 204F, 208E, 208F) when the originating device is known to be a customer communication device 108 or, additionally or alternatively, not known to be originating from a resource 202. Conversely, the same question may be routed to a selected resource 202 via an Agent-to-Agent channel (e.g., Agent-to-Agent channel 206, 210) when the originating device is known to be one of resource 202 or, additionally or alternatively, not known to be originating from a customer communication device 108. For example, if it is known that all agents (e.g., resources 202) use a particular range of IP addresses, MAC addresses, user identifier, machine name, physical location, etc., then questions may be solely allocated to the Agent-to-Agent channels (e.g., Agent-to-Agent channels 206, 210).

In other embodiments, the number of agents (e.g., resources 202) is greater than two. For example, a team, which may be previously determined or ad hoc, may be interconnected via their respective Agent-to-Agent channel 206. A previously determined team or teams may be utilized for particular types of calls. For example, a customer may have booked a domestic flight but need to add a stop. If the stop is in a different country, then the customs and other regulations required may be more complicated than merely adding the stop and adjusting the fare. Skills that could be taught to other agents but are likely to encounter such an issue so rarely they will often have difficulty recalling how to address the issue. While this even may not be so common that permanent team is established, but not so rare that contact center 102 can assume it will reoccur. Accordingly, having a “go to” collection of individuals who can resolve this issue may be beneficial. However, the specific agents utilized for a particular task may, or may not, be available when such a call is encountered. As a result, it may be necessary to utilize some or all different agents or different numbers or attributes for an agent. In another embodiment, a particular agent skill or attribute may be replaced with a different number or composition of agents. For example, it may be desirable to have an expert on international flight bookings to resolve an issue. However, two agents who have an above average knowledge may be able to resolve the issue in combination. While this may apply to some skills or attributes, it may not to others. For example, if supervisor is required to approve a large transaction, it may not be the case that two less-than supervisors can each approve a portion of the large transaction.

This may be particularly beneficial if not all required skills are present in one or two agents. For example, one resource 200 may be required to utilize a particular subject matter expertise, another resource 200 may be required to apply a particular agent skill (e.g., foreign language expertise, legal regulation knowledge, etc.), another resource 200 may be required to authorize an exception to a rule or limit, and/or other skill as may be needed to resolve the issue.

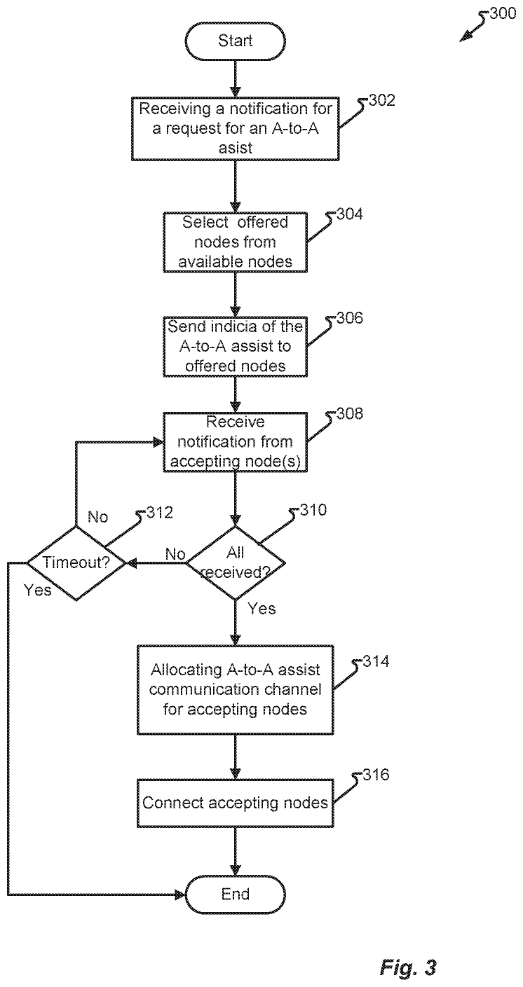

FIG. 3 depicts process 300 in accordance with embodiments of the present disclosure. In one embodiment, process 300 may be executed by at least one processor of one or more of work assignment mechanism 116, contact center 102, routing engine 132, and/or a combination thereof. In one embodiment, process 300 begins with step 302 receiving notification of a request for an Agent-to-Agent channel assist from one agent, such as a resource 202A for at least one other agent, such as resource 202B. The request may be explicit in terms of task or personnel required either by name, title, skill, and/or attribute. For example, “I need someone who can approve a $10,000 transaction,” “I need supervisor Johnson,” “I need an expert on product model number 10-1234,” etc. In other embodiments, notification received in step 302 may describe an issue or other subject matter. For example, “What does error code ‘1234’ mean?”, “I can't advance to the next screen for international bookings,” etc.

If the request is for an explicit person or type of person, an entity, such as contact center 102 may be configured to honor the request, which may comprise notification of the requestor of an estimated wait time, if the person is not currently available. Alternatively, requests may not be honored and the next available agent having the skill or other attribute required is considered. Accordingly, a system may access a database, rules, or other information to identify the personnel who can address the issue raised in step 302. As will be discussed in more detail below. Questions and answers may or may not be well formulated and automated systems may suggest or overwrite a poorly worded question (or answer) in favor of a previously identified well-worded question (or answer). For example, “What does error code ‘1234’ mean?” may be stored along with a preferred wording, such as, “Supervisor override authorization needed clear code ‘1234.’” to provide, an alternative wording and/or alternative meaning to address the same issue.

Step 304 selects nodes, such as one or more agent communication devices utilized by an associated one or more live agents to interact over network 104 and/or other networks, each agent-node comprising one of a number of resources 202 that have a skill or attribute determined necessary to resolve the issue, which may have been identified in step 302. Step 306 then sends a notification to such agents that utilization of Agent-to-Agent channel 206, for one or more resources 202, has been requested for resolution of an issue by an agent. Assuming at least two nodes are required, step 308 then receives a notification from accepting nodes, which may arrive at different times or not at all. Accordingly, test 310 determines if all notifications have been received and, if no, test 312 determines if process 300 has exceeded a timeout limit. If test 312 is determined in the affirmative, process 300 may end and the requesting agent (e.g., the agent initiating the notification in step 302) may be notified to seek resolution through other means. If test 312 is determined in the negative, then processing continues until step 308 receives another notification in step 308. Step 308 may be a null step if there are no notifications to receive. If test 310 determines that all requested agents have responded, then processing may continue to step 314. Step 314 then allocates the Agent-to-Agent channel for each notifying agent of step 308 and connected in step 302, including with the node requesting the Agent-to-Agent channel in step 302. It should be appreciated that step 306, test 308 and step 310 may be omitted if agents are not to be provided with the option of accepting an Agent-to-Agent channel interaction. Rather, once selected by step 304, process 300 proceeds directly to step 314 whereby Agent-to-Agent channel resource are allocated and connected in step 316.

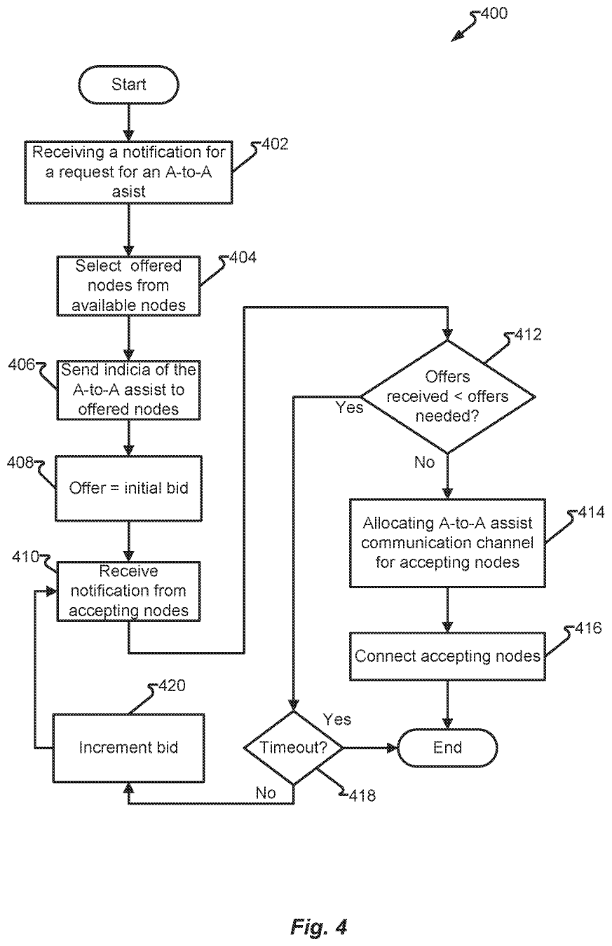

FIG. 4 depicts process 400 in accordance with embodiments of the present disclosure. In one embodiment, such as described with respect to process 300, nodes selected for an Agent-to-Agent channel interaction are notified and connected with, or without, agreeing to accept the Agent-to-Agent channel interaction. In embodiments were agents can accept, a bidding system may be implemented encourage acceptance of Agent-to-Agent channel interactions and/or Agent-to-Agent channel interactions associated with a particular topic or subject matter. While a bidding system may be structured in a variety of ways, herein we consider points that will be earned by successfully completing the Agent-to-Agent channel interaction. Having obtained successfully completion, the points bid are then credited to the agent(s) to be used manually or automatically. For example, certain work items may be “bought” with points obtained from bidding. These work items may be particularly easy, profitable, intellectually rewarding, required for promotion, etc. Such work items may be automatically provided via routing engine 132. For example, the next high-commission work item may be provided to the agent with sufficient, or the highest, points raised Agent-to-Agent channel interactions. Point values may be altered automatically or manual. For example, the agent requesting assistance may “spend” their points in order to obtain assistance via Agent-to-Agent channel interaction. In another embodiment, an agent may be entitled to ask for assistance with an initial point value and, if there are no or an insufficient number of “takers” then the bid is increased. As time is often critical when seeking the resolution of an issue via Agent-to-Agent channel interactions, bidding may increase quickly, such as every few seconds. To avoid being an unnecessarily distracting, agents may utilize a configured interface to bid on their behalf. For example, “Accept anything above 5 points for domestic bookings.” “Accept anything above 25 points for international bookings.” “Accept anything above 50 points for international rebooking including a change in country.” However, it may still be a requirement that the agent be available, that is, not be presently engaged on their Agent-to-Agent channel.

In one embodiment, process 400 beings with step 402 receiving notification for an Agent-to-Agent channel interaction from a requesting node associated with a live agent's agent communication device. Step 404 selects nodes from those available. Additionally or alternative, step 404, as described with respect to process 300, selects agents having a skill or attribute associated with a determined need of the Agent-to-Agent channel interaction. Step 406 then sends the notification to the selected nodes. Step 408 sets the offer amount to an initial bid amount, such as default or minimum amount. Step 410 receives notification from accepting bidding nodes associated with other agents via their respective agent communication device. Test 412 determines if the offers received are less than the offers needed, such as to obtain the number of agents or number of skills determined necessary to address the issue raised in in step 402. If test 412 is determined in the affirmative, process 400 may continue to test 418 that determines if a timeout has occurred and, if yes, process 400 may end. If test 418 is determined in the negative, processing may continue back to step 420 whereby the bid amount is incremented to further entice bidding. Processing then continues to step 410 to receive notifications. It may be that step 410 is a null step when no offers are received. Returning to test 412, if test 412 is determined in the negative then sufficient bidders have been found and processing continues to step 415 whereby Agent-to-Agent channels are allocated for the interaction and connected in step 416.

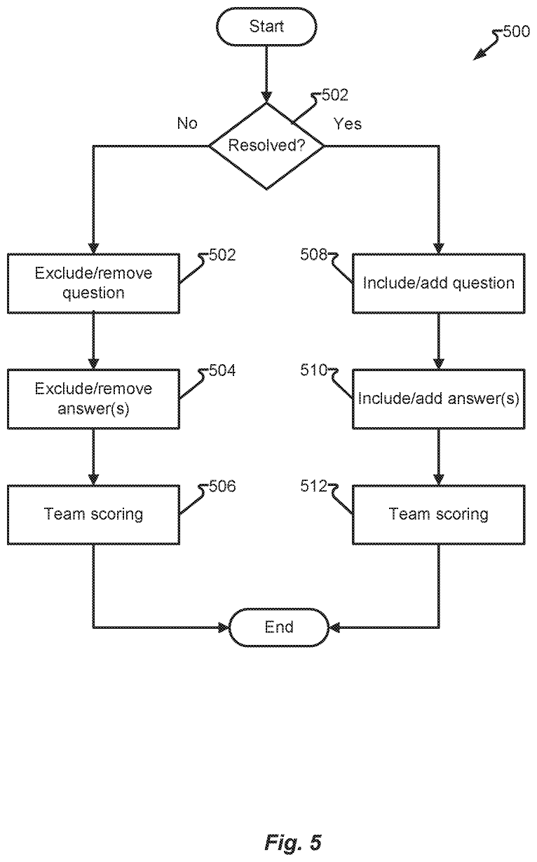

FIG. 5 depicts process 500 in accordance with embodiments of the present disclosure. In one embodiment, the success or failure of a particular notification, such as step 302 of process 300 or step 402 of process 400, may be evaluated. Evaluation may be in terms of the particular question asked and/or in the resolution provided. A failure to resolve the issue may be entered into a data repository as an example of what did not work well and/or a successful resolution may be entered in to a data repository as an example of what did work well.

Accordingly, and in one embodiment, process 500 may be executed by assignment mechanism 116, contact center 102, routing engine 132, and/or a combination thereof upon completion of an Agent-to-Agent channel interaction. Test 502 determines if the resolution was successful or not. Success or failure may be explicitly provided by the agent “Did that successfully resolve your issue (Yes/No)?” or by implication. For example, if the agent performed a suggested act and continued working with the customer then success may be inferred by a processor. Conversely, if the agent requesting Agent-to-Agent channel interaction and, after it was completed, did not continue to make progress with a customer or contacted another resource (e.g., help desk, supervisor, etc.) then failure may be inferred by the processor.

Embodiments of process 500 generally maintain an artifact of a question utilized to initiate an Agent-to-Agent channel interaction and/or resolve an issue presented therein. If test 502 determines the issue was successfully resolved, step 508 may include the question in a data repository and/or step 510 may include the answer in the repository. The repository may be embodied as a knowledge base, frequently asked questions, artificial intelligent (AI) assistant, etc. Similarly, agents that participated in the Agent-to-Agent channel interaction may be scored in step 512, scoring may comprise awards or rank improvement for providing a useful answer, routed a favorable work item, and/or increment in bidding currency.

Conversely, if test 502 is determined in the negative, step 502 may exclude or remove a question from a repository, exclude or remove an answer in step 504, and/or omit or decrement a score associated with the participating agents in step 506. It should be appreciated that scoring of team members may be applied to questions and/or answers. For example, a question/answer score may be improved, if successful in providing a resolution and decremented if not. Results may then be limited to only successful questions/answer and/or presented in a ranking.

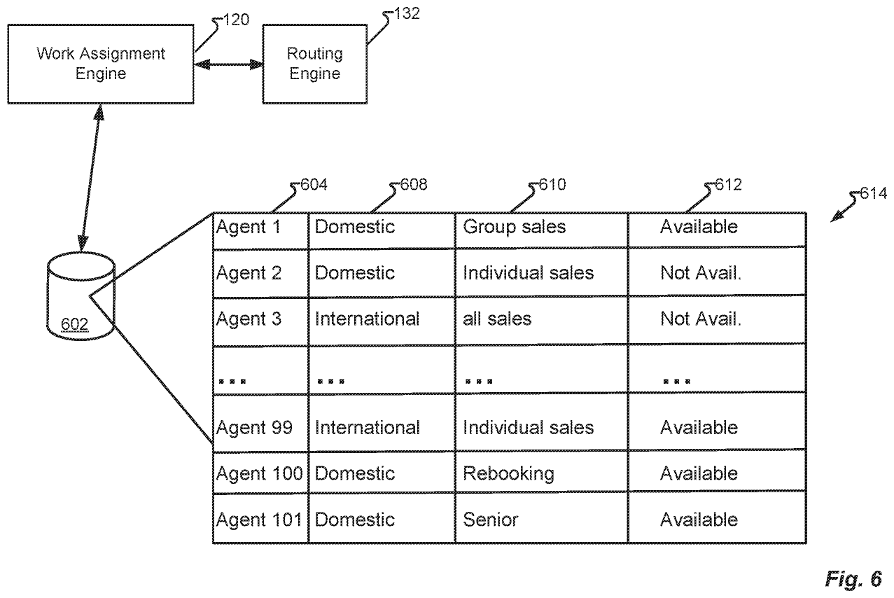

FIG. 6 depicts data storage system 600 in accordance with embodiments of the present disclosure. In one embodiment, a processor such as one executing contact center 102, routing engine 132, and/or other component, accesses database 602 comprising data structure 614. Data structure 614 may be variously structured (e.g., flat file, relational database, spreadsheet, etc.) and comprise one or more fields. For example, field 604 comprises an agent identifier, field 608 comprises one agent attribute in the form of a department or area of expertise, field 610 comprises an agent skill, field 612 comprises an identifier indication whether the agent is currently available or not for an Agent-to-Agent channel interaction. For example, for an agent associated with resource 202A, whether Agent-to-Agent channel 206 is presently engaged. Such information may also be available via accessing other data sources, for example, field 612 may comprise an address or identifier of presence information which may be maintained by routing engine 132 and/or other presence server.

In one embodiment, a processor receives a notification for an Agent-to-Agent channel interaction and determines that a particular subject matter(s) is needed and identifies agent skills and/or attributes, for example in fields 608 and 610, matching the subject matter(s). If the associated agent availability field 616 indicates the agent is available, the agent is notified or presented with an Agent-to-Agent channel interaction.

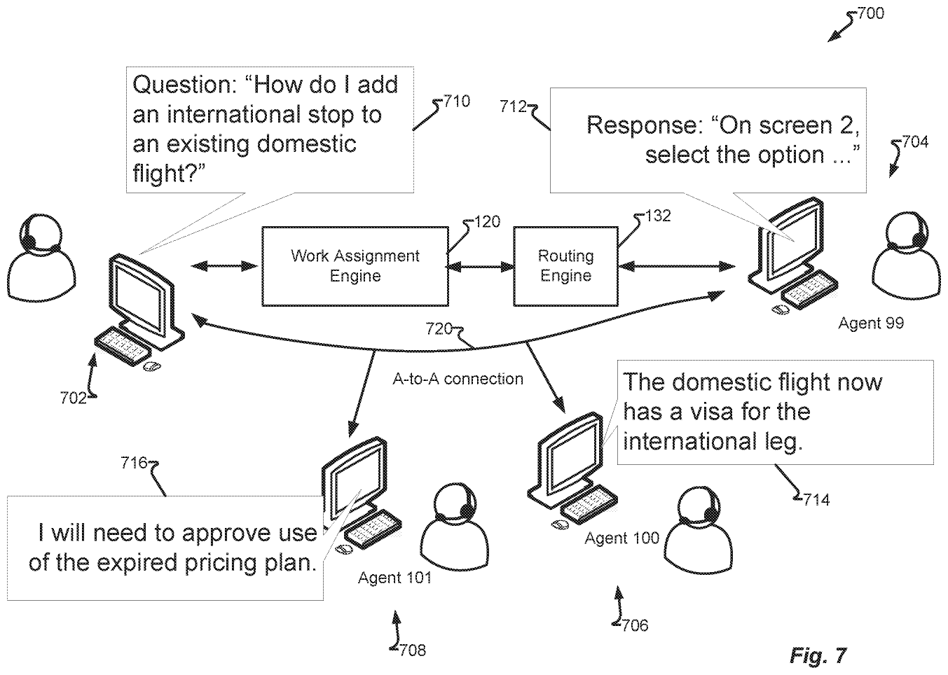

FIG. 7 depicts interaction 700 in accordance with embodiments of the present disclosure. In one embodiment, resource 702, 704, 706, and 708 are embodiments of a resource 112 when comprising an agent communication device operable to receive inputs from an agent (e.g., audio, video, tactile, etc.) for transmission on a network, such as network 104, and/or a separate network, such as an internal (e.g., LAN, subnet, etc.) to contact center 102 utilized for communication between resource 702, 704, 706, and 708 whether or not a portion of such internal network are utilized for external communications with customer communication device(s) 108.

In one embodiment resource 702 asks question 710 that may be received by contact center 102 component, such as work assignment engine 120 and/or routing engine 132 and determined to be a notification requesting an Agent-to-Agent assist via an Agent-to-Agent channel interaction from either a specific agent (e.g., “Agent Smith”), group of agents (e.g., “someone in international reservations”), or contextually determined (e.g., “ . . . add an international stop . . . ” will be directed to international reservations), such as by a processor of work assignment engine 120 and/or routing engine 132 accessing table 614 in database 602 or other repository. Agents that are determined by the processor, with benefit of one or more algorithms such as process 300 and/or process 400, as being necessary to resolve the issue raised in the question are then selected and notified. Notification may be a request or offer, such as an opportunity to bid on a response, or directly connected such as via their respective Agent-to-Agent channel (e.g., see FIG. 2, refs. 206 and 210). If a particular agent is not available, the requestor may be notified that all agents deemed necessary are not currently available. This may cause the notification to be enqueued or trigger a failure notification to alert resource 702 to seek resolution elsewhere. Alternative agents may be selected as they become available.

Resource 702, 704, 706, and 708 are connected for an Agent-to-Agent channel interaction 720 to provide exchange comprising responses 712, 714, and/or 716 in response to notification 710. In another embodiment, once Agent-to-Agent channel interaction 720 has concluded, each member of the ad hoc team may be scored and/or questions or answers may be utilized to populate or update a knowledge base so that good questions (or answers) may be identified and relied upon more heavily by automated systems or human searches to resolve similar issues in the future.

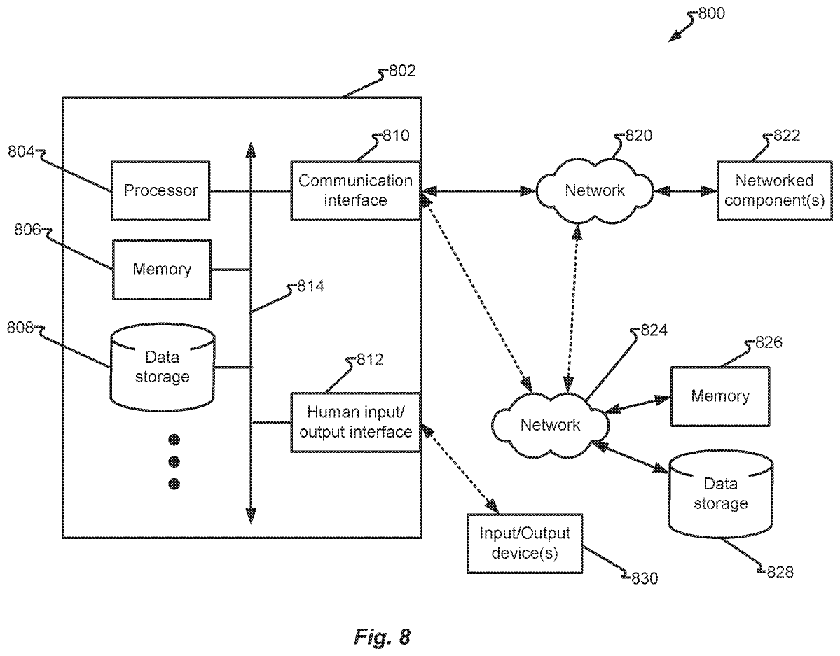

FIG. 8 depicts device 802 in system 800 in accordance with embodiments of the present disclosure. In one embodiment, one or more of work assignment engine 120, routing engine 132, an agent communication device comprising a resource, such as resource 202, may be embodied, in whole or in part, as device 802 comprising various components and connections to other components and/or systems. The components are variously embodied and may comprise processor 804. Processor 804 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 804, executes instructions, and outputs data, again such as via bus 804.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Additionally or alternatively, input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, etc. In another embodiment, communication interface 810 may comprise, or be comprised by, input/output interface 812. Communication interface 810 may be configured to communicate directly with a networked component or utilize one or more networks, such as network 820 and/or network 824.

Network 104 may be embodied, in whole or in part, as network 820. Network 820 may be a wired network (e.g., Ethernet), wireless (e.g., WiFi, Bluetooth, cellular, etc.) network, or combination thereof and enable device 802 to communicate with network component(s) 822.

Additionally or alternatively, one or more other networks may be utilized. For example, network 824 may represent a second network, which may facilitate communication with components utilized by device 802. For example, network 824 may be an internal network to contact center 102 whereby components are trusted (or at least more so) that networked components 822, which may be connected to network 820 comprising a public network (e.g., Internet) that may not be as trusted. Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and allow device 802, and/or other devices, to access data thereon. Similarly, input/output device(s) 830 may be accessed by processor 804 via input/output interface 812 and/or via communication interface 810 either directly, via network 824, via network 820 alone (not shown), or via networks 820 and 824.

It should be appreciated that computer readable data may be sent, received, stored, processed, and presented by a variety of components. It should also be appreciated that components illustrated may control other components, whether illustrated herein or otherwise. For example, one input/output device 830 may be a router, switch, port, or other communication component such that a particular output of processor 804 enables (or disables) input/output device 830, which may be associated with network 820 and/or network 824, to allow (or disallow) communications between two or more nodes on network 820 and/or network 824. For example, a connection between one particular customer, using a particular customer communication device 108, may be enabled (or disabled) with a particular resource 812. Similarly, one particular resource 112 may be enabled (or disabled) from communicating with a particular other resource 112. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system providing communications between nodes on a network, comprising:
a microprocessor;
a memory;
a network interface facilitating communications between nodes on the network, wherein each of the nodes is configured to engage communications utilizing a fixed number of communication channels allocated by the microprocessor between a first portion allocated for communications with nodes known to be associated with nodes being customer communication devices and a second portion allocated for nodes known to be associated with nodes being agent communication devices;
upon receiving notification, from a requesting node of the number of nodes, for an Agent-to-Agent assist task, selecting offered nodes of the number of nodes eligible to receive the Agent-to-Agent assist and sending to the offered nodes, indicia of the Agent-to-Agent assist; and
upon receiving notification, from an accepting node of the offered nodes, acceptance of the Agent-to-Agent assist, allocating one of the fixed number of communication channels for each of the requesting node and accepting nodes and connecting the requesting node and the accepting node thereon.

2. The system of claim 1, wherein
allocating one of the fixed number of communication channels for each of the requesting node and accepting nodes and connecting the requesting node and the accepting node thereon comprises allocating one of the second portion and connecting the requesting node and the accepting node thereon.

3. The system of claim 1, wherein receiving notification comprises receiving from a plurality of the offered nodes, a bid amount and designating the highest bidding offered node as the accepting node.

4. The system of claim 3, further comprising adjusting an account associated with the accepting node, by the bid amount.

5. The system of claim 3, further comprising:
obtaining a minimum bid amount; and
wherein sending indicia of the Agent-to-Agent assist to the offered nodes further comprises sending a minimum bid amount.

6. The system of claim 5, wherein each of the offered nodes are selected from the nodes having an associated account with a value being at least the minimum bid amount.

7. The system of claim 1, further comprising:
a benefit amount; and
wherein successfully completing the Agent-to-Agent assist provides the accepting node the benefit amount.

8. The system of claim 7, further comprising:
the microprocessor determining that at least one of the nodes is associated with a benefit amount greater than a threshold and, in response thereto, routing at least one work task thereto, wherein the work task is designated as a premium work task.

9. The system of claim 1, further comprising, upon receiving the notification, from the accepting node, revoking, to each of the offered nodes other than the accepting node, indicia of the Agent-to-Agent assist.

10. The system of claim 1, further comprising:
accessing an attribute associated with the notification; and
wherein selecting the offered nodes further comprises selecting, from the number of nodes, the offered nodes having a record in the memory indicating interest notifications having the attribute.

11. An agent communication device, comprising:
a microprocessor;
a memory;
a network interface facilitating communications via the network;
wherein the microprocessor is configured to engage a fixed number of communication channels, via the network allocated by the microprocessor between a first portion allocated for communications with nodes known to be associated with nodes being customer communication devices and a second portion allocated for nodes known to be associated with nodes being agent communication devices;
upon receiving notification of an Agent-to-Agent assist task being available, presenting indication of the Agent-to-Agent assist task on a display component; and
upon receiving an input from an agent indicating a desire to have the Agent-to-Agent assist task, routing the Agent-to-Agent assist to the agent communication device.

12. The agent communication device of claim 11, further comprising
receiving the Agent-to-Agent assist task comprises a communication utilizing the second portion of the fixed number of communication channels.

13. The agent communication device of claim 11, wherein the microprocessor, upon receiving an expiration notification of the Agent-to-Agent assist task, terminates the presenting of the Agent-to-Agent assist task on the display component.

14. The agent communication device of claim 11, wherein receiving the input from the agent indicating the desire to have the Agent-to-Agent assist task comprises receiving, from the agent, the input comprising a bid amount associated with indicia of a value in an account.

15. The agent communication device of claim 14, wherein presenting the indicia of the Agent-to-Agent assist task on the display component is omitted upon the microprocessor determining the value in the account is less than a minimum bid associated with the Agent-to-Agent assist task.

16. A method for managing connectivity between nodes on a network, comprising:
receiving, from a requesting node of the nodes on the network, notification of an Agent-to-Agent assist request, wherein each of the nodes on the network has a fixed number of communication channels for use in communicating with other nodes on the network, wherein the fixed number of communication channels are allocated between a first portion allocated for communications with nodes known to be associated with nodes being customer communication devices and a second portion allocated for nodes known to be associated with nodes being agent communication devices;
sending, from a router, indicia of the notification to a plurality of offered nodes of the nodes on the network;
receiving, from an accepting node of the offered nodes, indicia of acceptance; and
upon receiving the indicia of acceptance, allocating one of the fixed number of communication channels for each of the requesting node and accepting nodes and connecting the requesting node and the accepting node thereon.

17. The method of claim 16,
wherein the allocating the one of the fixed number of communication channels for each of the requesting node and accepting nodes and connecting the requesting node and the accepting node thereon, further comprises allocating one of the second portion and connecting the requesting node and the accepting node thereon.

18. The method of claim 16,
wherein receiving the notification comprises receiving, from a plurality of the offered nodes, a bid amount and designating the highest bidding offered node as the accepting node.

19. The method of claim 16, further comprising:
obtaining a minimum bid amount associated with the Agent-to-Agent assist; and
wherein sending indicia of the Agent-to-Agent assist to the offered nodes further comprises sending a minimum bid amount.

20. The method of claim 19, wherein each of the offered nodes are selected from the nodes having an associated account with a value being at least the minimum bid amount.
